(19) United States
(12) Patent Application Publication
(10) Pub. No.: US 2013/0309092 A1
(43) Pub. Date: Nov. 21, 2013

(54) ROTOR BLADE WITH HEATING DEVICE FOR A WIND TURBINE

(71) Applicant: Gerhard Lenschow, Aurich (DE)

(72) Inventor: Gerhard Lenschow, Aurich (DE)

(73) Assignee: WOBBEN PROPERTIES GMBH, Aurich (DE)

(21) Appl. No.: 13/882,951

(22) PCT Filed: Oct. 31, 2011
(86) PCT No.: PCT/EP2011/069120

§ 371 Date: Jul. 11, 2013

(30) Foreign Application Priority Data
Nov. 4, 2010 (DE) 10 2010 043 434.5

(51) Int. Cl. F03D 11/00

(52) U.S. Cl. CPC F03D 11/0025
USPC 416/95

(57) ABSTRACT

There is provided a wind power installation rotor blade comprising at least one electrically operable heating mat which is fixed in the interior of the rotor blade.

### BACKGROUND

1. Technical Field

The invention concerns a wind power installation rotor blade.

2. Description of the Related Art

As wind power installations are erected at many different locations it can happen that the ambient conditions and in particular the ambient temperature is so low that icing occurs at the wind power installation and in particular the rotor blades. That icing is disadvantageous because people in the area around the wind power installation can be endangered by ice breaking off. In addition icing of the rotor blades can result in the rotor of the wind power installation being unbalanced and in a reduction in yield.

### BRIEF SUMMARY

Embodiments of the present invention are directed to providing a wind power installation rotor blade and a wind power installation, which permits de-icing of the rotor blade.

In one embodiment there is provided a wind power installation rotor blade having at least one electrically heatable heating mat which is fixed in the interior of the rotor blade.

In an aspect of the present invention the heatable heating mats are silicone mats with a heating element. The silicone mats are fixed with silicone in the interior of or in a hollow space in the rotor blade.

In a further aspect of the invention the heating mats are in the form of silicone gel heating mats and have an electrical heating element.

In a further aspect of the invention there is provided a wind power installation having a rotor blade as described hereinbefore.

The invention concerns the idea of providing a wind power installation rotor blade having at least one heating mat (fixed in the interior of the rotor blade or to the inside contour of the rotor blade), which can permit electrical heating or warming of the rotor blade of the wind power installation to avoid ice accretion.

The heating mats can be used in particular in relation to rotor blades comprising a plurality of parts. In addition fixing of heating mats to the rotor blades is not easily obtained in particular in the case of rotor blades with a steel segment.

According to the invention the heating mats are fixed in the inside region of the rotor blades. The heating mats can be fixed in position for example by an adhesive process. The adhesive for gluing the heating mats in place can be applied for example in a spray process whereby the surface quality of the adhesive layer can be improved. Alternatively the adhesive can be applied by rolling.

As an alternative thereto the heating mats can be fixed in the interior of the rotor blade by an adhesive sealing strip or an adhesive film.

The provision of heating mats in the interior of the rotor blade is advantageous because that can be easily effected, this solution is easily scalable, the masses involved are low, the heating mats have a long service life, fixing of the heating mats is suitable for mass production, involves low costs, is service-friendly, is robust and can be used both in relation to steel rotor blades, GRP rotor blades and also CRP rotor blades.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a cross-section through a wind power installation rotor blade in accordance with a first embodiment,

FIG. 2 shows a further cross-section through a rotor blade of a wind power installation rotor blade according to the first embodiment, and

FIG. 3 shows a diagrammatic view of a wind power installation in accordance with a second embodiment.

### DETAILED DESCRIPTION

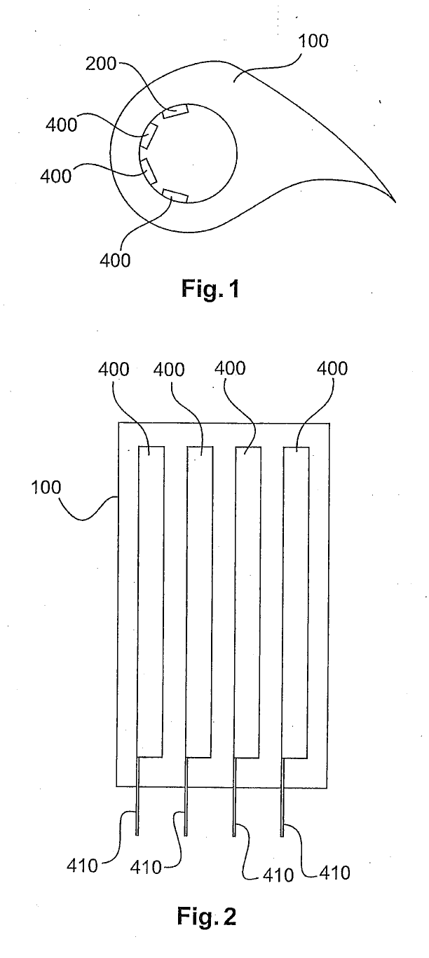

FIG. 1 shows a cross-section through a wind power installation rotor blade according to a first embodiment of the invention. In the interior the rotor blade 100 has an opening or a hollow space (or inside contour) 200 extending along the longitudinal direction of the rotor blade. At least one and preferably a plurality of electrical heating mats 400 are provided at the periphery of the opening 200. The coupling between the inside wall of the opening 200 and the heating mats 400 preferably is of good thermal conductivity. Optionally the connection can have electrically insulating properties.

FIG. 2 shows a further cross-section through a rotor blade 100 according to the invention. A plurality of electrically operable heating mats 400 can be provided within the rotor blade or within the opening 200. The heating mats 400 have at least one electrical connection 410, by way of which the required electrical power can be supplied. By the supply of electrical power the heating mats 400 are for example electrically heated and can deliver their heat to the rotor blade so that the rotor blade is also warmed. Electrical heating wires electrically connected to the connections 410 can be provided within the heating mat 400.

The heating mats according to the invention can be in the form of silicone heating mats or also aluminum films or mats. The silicone heating mats can be fixed to the inside of the rotor blade by spraying silicone onto or at the blade. In that respect care is to be taken to prevent or reduce air inclusions from occur in the gluing operation. Air inclusions may have the effect that unwanted increased heating of the heating mats can occur at those locations, as the heat is not be suitably delivered to the rotor blade at those locations. Glueing the heating mats with silicone however has some disadvantages as the mats are fixedly glued in position and they may not therefore be readily replaced.

In a further aspect of the invention the heating mats can be glued in place by a silicone gel or the heating mats themselves can be in the form of silicone gel adhesive mats. The use of gel adhesive mats as the heating mats is advantageous as the mats can be replaced without being ruined. Gel adhesive mats are also advantageous in production as in that case no unwanted aerosols can occur. The use of gel adhesive mats is also advantageous because it is possible in that way to avoid air bubbles in the adhesive application process and the adhesive layer thicknesses can be quickly and reliably attained.

The heating mats can for example have electrically conductive threads which are heated when the heating mats are supplied with electrical energy.

In accordance with the invention the heating mats can be used both in the region near the rotor blade root and also in the region of the rotor blade tip or in the middle region of the rotor blade in order to heat the rotor blade and avoid icing.

In an aspect of the invention the heating mats can be in the form of silicone mats with a fabric disposed therein. A heating thread is provided in addition thereto. The heating thread can also be in the form of the fabric.

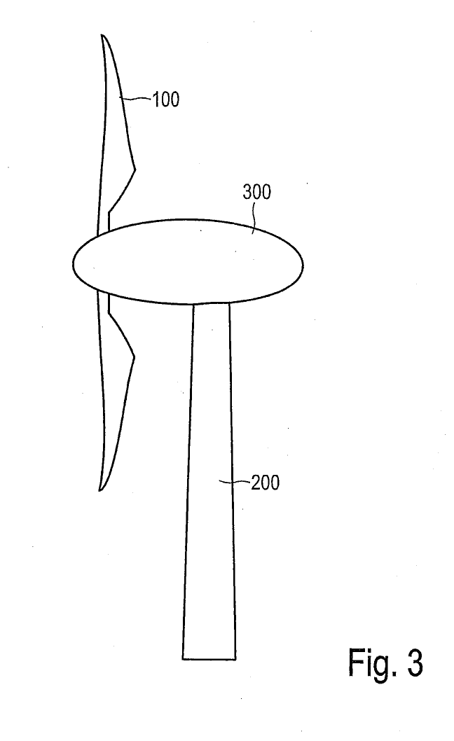

FIG. 3 shows a diagrammatic view of a wind power installation according to a second embodiment in which rotor blades having heating mats therein are mounted to the wind power installation. The wind power installation has a pylon 200, on the pylon a pod 300, and a plurality of rotor blades 100. Preferably the wind power installation has three rotor blades 100. The rotor blades of the second embodiment can be based on the rotor blades of the first embodiment. Advantageously, the electrical current can be supplied to the electrical connection 410 and heat the heating mats by way of the wind power generator itself. That is, the current comes directly from the generator because the heating mats of this type operate efficiently over a wide range of frequencies and thus the current can be delivered directly from the generator and does not need to go through a rectifier and converter first. Thus, the system is significantly more efficient and does not result in losses due to conversion circuits.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind power installation rotor blade comprising:
a blade body having an opening and an interior surface; and
at least one electrically operable heating mat located in the opening and fixed to the interior surface of the blade body.

2. The wind power installation rotor blade according to claim 1 wherein the heating mats are silicone mats and include a heating element, and wherein the silicone mats are fixed with silicone to the interior surface of the rotor blade.

3. The wind power installation rotor blade according to claim 1 wherein the heating mats are in the form of silicone gel heating mats and include a heating element.

4. The wind power installation rotor blade according to claim 1 wherein the opening of the blade body extends along the longitudinal direction of the blade body, and wherein at least one electrically operable heating mat extends in the longitudinal direction of the blade body.

5. A wind power installation comprising:
a rotor blade including:
a blade body having an outer surface and an interior surface, the inner surface forming an opening; and
a heating mat located in the opening and fixed to the interior surface of the blade body,

6. The wind power installation according to claim 5 wherein the heating mat is a silicone heating mat that includes an electrical heating element.

7. The wind power installation according to claim 6 wherein the silicone heating mat is a silicone gel heating mat.

8. The wind power installation according to claim 6 wherein heating mat is fixed to the interior surface of the blade by an adhesive material.

9. The wind power installation according to claim 6 wherein adhesive material is thermally conductive.

10. The wind power installation according to claim 6 wherein the heating mat is an aluminum film or mat.

11. The wind power installation according to claim 6 further comprising a plurality of heating mats located in the opening and fixed to the interior surface, each of the heating mats extending in a longitudinal direction of the blade body.

12. The wind power installation according to claim 6 wherein each of the heating mats are spaced apart from each other.
